(19) United States
(12) Patent Application Publication
(10) Pub. No.: US 2026/0356089 A1
(43) Pub. Date: Nov. 12, 2026

(54) NICKEL ALLOY SCREEN PLATE AND HOT-PRESSING DEVICE THEREOF AND PROCESS FOR MANUFACTURING NICKEL ALLOY SCREEN PLATE

(71) Applicant: CHANGZHOU SANYANG PRECISION PLATE MAKING CO., LTD., Changzhou (CN)

(72) Inventors: Liwen FENG, Changzhou (CN); Xugui CHEN, Changzhou (CN); Jiaqun NI, Changzhou (CN)

(21) Appl. No.: 19/317,212

(22) Filed: Sep. 3, 2025

Related U.S. Application Data
(63) Continuation of application No. PCT/CN2025/095432, filed on May 16, 2025.

(30) Foreign Application Priority Data
May 7, 2025 (CN) 202510584137.4

(51) Int. Cl. B41F 15/36; B21D 22/02; B32B 3/30; B32B 15/09

(52) U.S. Cl. CPC B41F 15/36; B21D 22/022; B32B 3/30; B32B 15/09; B32B 2250/02; B32B 2311/22

(57) ABSTRACT

A nickel alloy screen plate hot-pressing device and a process for manufacturing a nickel alloy screen plate. The nickel alloy screen plate hot-pressing device includes a machine case, a hot-pressing assembly is mounted on the machine case, the hot-pressing assembly includes a support column, the support column is mounted on the machine case, a base plate is mounted on the support column, a heating table is mounted on the base plate, a first pressing plate and a second pressing plate for pressing are mounted on the machine case, a transportation apparatus is mounted on the machine case, the transportation apparatus includes a support table, a first guide rod is mounted on the support table, a first sliding block is slidably mounted on the first guide rod, and the first sliding block is connected to a carrier plate for transporting a first frame.

### CROSS-REFERENCE TO RELATED APPLICATIONS

The present application is a continuation application of PCT application No. PCT/CN2025/095432, filed on May 16, 2025, which claims priority to Chinese patent application No. 202510584137.4, filed on May 7, 2025. The entireties of PCT application No. PCT/CN2025/095432 and Chinese patent application No. 202510584137.4 are hereby incorporated by reference herein and made a part of this specification.

### TECHNICAL FIELD

The present application relates to the technical field of printing devices, and more particularly, to a nickel alloy screen plate and a hot-pressing device thereof and a process for manufacturing the nickel alloy screen plate.

### BACKGROUND ART

With the development of science and technology, printing technology has become more and more perfect, and the production and manufacturing industry of printing screen plates has increasingly high requirements and high standards.

The nickel alloy screen plate is also a type of printing screen plate, and the manufacturing process of the nickel alloy screen plate usually includes a hot-pressing process for processing. In most hot-pressing devices, a polyester screen and an adhesive film are usually laid manually, and then a frame is manually taken and placed on a hot-pressing workbench. However, in the process of manually taking and placing the frame, it is not easy to align the frame with the polyester screen and the adhesive film, and when the frame is manually placed on the polyester screen, if a position of the frame is to be adjusted again, the frame will drag the polyester screen to move and change a position of the polyester screen, which makes it necessary to adjust the position of the polyester screen manually and repeatedly and increases work difficulty and leads to low production efficiency in processing and production.

### SUMMARY

In order to improve the convenience of the nickel alloy screen plate hot-pressing device during use, the present application provides a nickel alloy screen plate hot-pressing device.

The present application provides a nickel alloy screen plate, adopting the following technical solutions.

A nickel alloy screen plate, including a bottom frame, a polyester screen is adhered to the bottom frame, a nickel alloy screen is adhered to the polyester screen, an ink retaining groove, an ink storage groove and a silver paste groove are formed on the nickel alloy screen, the silver paste groove is provided on a bottom surface of the ink storage groove, and the silver paste groove penetrates through the nickel alloy screen.

Forming the ink retaining groove on mesh bars of the nickel alloy screen makes the toner stay in the printing operation and enhances the printing effect, and forming the ink storage groove and the silver paste groove makes it possible to store a small amount of toner when the toner passes through the ink storage groove, so as to ensure that the toner can be filled in each position in time during the printing process using the nickel alloy screen plate, so as to avoid the phenomenon of white-out in the printing process, which results in the occurrence of printing traces of weak ink or lack of ink during printing.

A nickel alloy screen plate hot-pressing device, including a machine case, a hot-pressing assembly is mounted on the machine case, the hot-pressing assembly includes a support column, the support column is mounted on the machine case, a base plate is mounted on the support column, a heating table is mounted on the base plate, a first pressing plate and a second pressing plate for pressing are mounted on the machine case, a transportation apparatus is mounted on the machine case, the transportation apparatus includes a support table, a first guide rod is mounted on the support table, a first sliding block is slidably mounted on the first guide rod, and the first sliding block is connected to a carrier plate for transporting a first frame.

By adopting the above technical solution, the worker first places the polyester screen on the heating table; then places the first adhesive film on the polyester screen, and places the first frame on the carrier plate of the transportation apparatus; the first frame is smoothly and quickly transported to a position above the heating table by the transportation apparatus, and through the pressing of the first pressing plate and the second pressing plate, the nickel alloy screen printing plate can be processed and produced quickly, which is beneficial to improving the convenience of the hot-pressing device during use.

In a specific embodiment, a mounting cavity is formed on the carrier plate, a sliding rod is slidably mounted on the carrier plate, a first end of the sliding rod extends into the mounting cavity, a second end of the sliding rod is provided outside the carrier plate, and a first push rod is mounted on the second end, outside the carrier plate, of the sliding rod and a second push rod is connected to the first end, extending into the mounting cavity, of the sliding rod; a support rod is mounted on the carrier plate, a movable rod is slidably mounted on the support rod, and a first end, close to the second push rod, of the movable rod is connected to the second push rod; a rotating rod is rotatably mounted on the carrier plate, and a carrier sheet for bearing the first frame is mounted on the rotating rod; and a push plate is mounted on the movable rod, and a first connecting rod for controlling rotation of the rotating rod is connected to the push plate.

By adopting the above technical solution, the first frame is placed on the carrier sheet, when the first frame moves to the position above the heating table, the first push rod is pushed and thus controls a movement of the movable rod, then the movable rod drives the push plate and the first connecting rod to move so as to quickly control the rotation of the rotating rod, and when the rotating rod drives the carrier sheet to rotate away from a position beneath the first frame, the first frame quickly and smoothly falls on the heating table.

In a specific embodiment, a guide rail is mounted on the rotating rod, the first connecting rod is slidably connected to the guide rail, and the guide rail is divided into two sections, wherein a first section is provided in parallel with the rotating rod, and a second section is provided in parallel with the movable rod.

By adopting the above technical solution, the guide rail is divided into two sections, the first connecting rod is used to slide in the guide rail, and the rotating rod is controlled to rotate by the guide rail, such that the carrier sheet is quickly controlled to rotate away from and rotate to the position beneath the first frame, and the rotating rod and the carrier sheet are flexibly controlled to receive and release the first frame, such that manual handling and placing of the first frame are avoided, which is beneficial to improving the efficiency of processing and production.

In a specific embodiment, the carrier sheet is defined with an inclined surface.

By adopting the above technical solution, the carrier sheet is defined with an inclined surface, such that the carrier sheet can be smoothly rotated to the position beneath the first frame, thereby preventing the first frame from being knocked.

In a specific embodiment, a sliding rail is mounted on the carrier plate, a second guide rod is mounted on the sliding rail, a second sliding block is slidably mounted on the second guide rod, a first spring is sleeved on the second guide rod, a first end of the first spring is connected to the second sliding block, a second end of the first spring is connected to the sliding rail, a push block is mounted on the second sliding block, a first end, close to the push plate, of the push block is connected to the push plate, and a clamping plate for fixing the first frame is mounted on the push block.

By adopting the above technical solution, when the push plate moves, the push plate can control the push block to slide on the second guide rod, such that the push block moves out of the mounting cavity to clamp the first frame, and the way of bearing the carrier plate by the first frame is converted from support by the carrier sheet to clamping by the clamping plate, so as to facilitate the subsequent off-force of the carrier sheet.

In a specific embodiment, a first side, close to the push block, of the push plate is defined with a beveled surface, a first side, close to the push plate, of the push block is defined with an outwardly convex arc-shaped surface, and a position of the beveled surface of the push plate abuts against the arc-shaped surface of the push block.

By adopting the above technical solution, the push plate can smoothly push the push block out for clamping the first frame by using the action of the arc-shaped surface and the beveled surface.

In a specific embodiment, a third guide rod is mounted on the push block, a third sliding block is slidably mounted on the third guide rod, a second spring is sleeved on the third guide rod, a first end of the second spring is connected on the third sliding block, a second end of the second spring is connected to the push block, and the clamping plate is connected on the third sliding block.

By adopting the above technical solution, the clamping plate is mounted on the third sliding block, and the third sliding block is supported by the second spring, such that the clamping plate can follow the up and down movements of the first frame when the first frame is pressed. Namely, firstly, it is convenient to quickly press the first frame on the heating table, and secondly, after the hot-pressing is completed, the first frame can be lifted by using an elastic force of the second spring, and it is convenient for the worker to move the first frame out of the heating table.

In a specific embodiment, a soft cushion block is mounted on the clamping plate.

By adopting the above technical solution, the soft cushion block is mounted on the clamping plate, such that the clamping force of the clamping plate on the first frame A is converted from a rigid force to an elastic force, which can not only clamp the first frame, but also prevent the clamping plate from damaging the first frame and thus protect the first frame.

A process for manufacturing the nickel alloy screen plate, including the following steps:
step 1, hot-pressing the polyester screen: placing the polyester screen at a hot-pressing position of the hot-pressing assembly, and laying a first adhesive film on the polyester screen by a worker; and then transporting the first frame onto the first adhesive film via the transportation apparatus by the worker, and bonding the first frame and the polyester screen together by using the first adhesive film via the hot-pressing assembly;
step 2, hot-pressing the nickel alloy screen: laying the nickel alloy screen on the first adhesive film, and bonding the nickel alloy screen to the polyester screen by using the first adhesive film via the hot-pressing assembly;
step 3, cutting the polyester screen: cutting the polyester screen, wherein an area of the polyester screen cut is smaller than an area of the nickel alloy screen;
step 4, pasting an aluminum frame on the polyester screen: preparing the aluminum frame, wherein a frame size of the aluminum frame is smaller than that of the first frame and the aluminum frame is able to be placed inside the first frame, placing the first frame above the aluminum frame and adjusting a position of the first frame such that an edge line of the nickel alloy screen is aligned with an edge line of the aluminum frame to ensure that the nickel alloy screen is at a center position of the aluminum frame, and gluing an adhesive on the aluminum frame and lifting the aluminum frame and pasting the aluminum frame with the polyester screen on the first frame;
step 5, controlling a tension of the polyester screen: detecting a surface tension of the polyester screen by using a tension meter by the worker, and adjusting the tension of the polyester screen by changing a height of the polyester screen lifted by the aluminum frame;
step 6, cutting the polyester screen again: cutting the polyester screen between the first frame (11) and the aluminum frame by the worker; and
step 7, after the cutting is completed, pasting an edge line of the cut polyester screen with an adhesive, such that the edge line of the polyester screen is pasted on the aluminum frame.

In a specific embodiment, the first adhesive film is contoured in a shape of a rectangular ambulatory plane.

By adopting the above technical solution, the first adhesive film is contoured in the shape of the rectangular ambulatory plane, eliminating the need for cutting the first adhesive film during subsequent cutting of the polyester screen, and the material of the adhesive film is also saved.

In summary, the present application includes at least one of the following beneficial technical effects:
1. The worker first places the polyester screen on the heating table; then places the first adhesive film on the polyester screen, and places the first frame on the carrier plate of the transportation apparatus; the first frame is smoothly and quickly transported to a position above the heating table by the transportation apparatus, and through the pressing of the first pressing plate and the second pressing plate, the nickel alloy screen printing plate can be processed and produced quickly, which is beneficial to improving the convenience of the hot-pressing device during use.

### BRIEF DESCRIPTION OF THE DRAWINGS

FIG. 1 is an exploded diagram of a nickel alloy screen plate according to an embodiment of the present application.

FIG. 2 is a schematic diagram of a nickel alloy screen plate hot-pressing device according to an embodiment of the present application.

FIG. 3 is a schematic diagram of a hot-pressing assembly according to an embodiment of the present application.

FIG. 4 is a schematic diagram showing a relationship of mounting positions of a first pressing plate and a second pressing plate according to an embodiment of the present application.

FIG. 5 is a sectional diagram of a carrier plate according to an embodiment of the present application.

FIG. 6 is a schematic diagram of a mounting manner of a movable rod according to an embodiment of the present application.

FIG. 7 is a schematic diagram of a mounting position of a rotating rod according to an embodiment of the present application.

FIG. 8 is a sectional diagram of a push block according to an embodiment of the present application.

FIG. 9 is a schematic diagram of a carrier sheet according to an embodiment of the present application.

FIG. 10 is a schematic diagram of a nickel alloy screen according to an embodiment of the present application.

FIG. 11 is an enlarged diagram at A in FIG. 10.

FIG. 12 is a cross-sectional diagram of a nickel alloy screen without an ink storage groove according to an embodiment of the present application.

### DETAILED DESCRIPTION

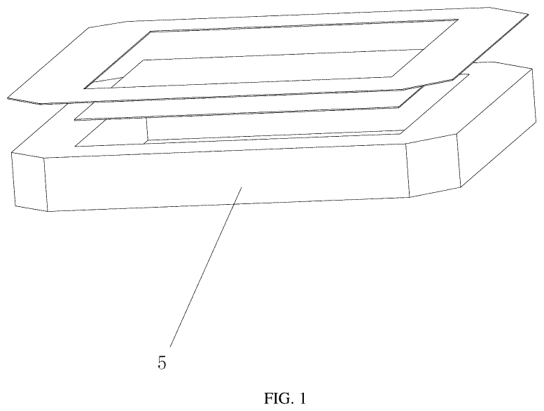

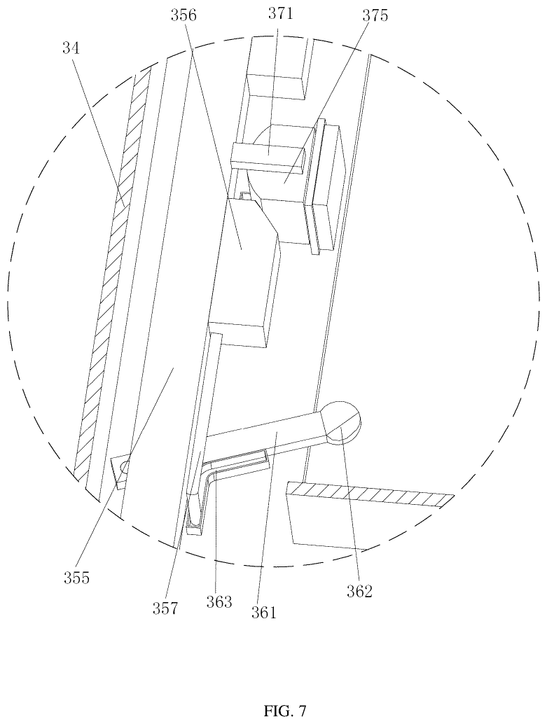

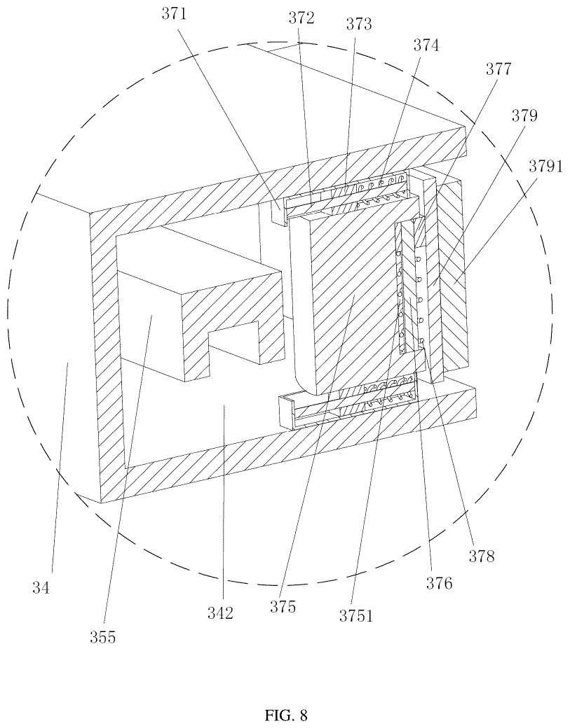

The present application is further described with reference to FIGS. 1-12.

Disclosed in an embodiment of the present application is a nickel alloy screen plate, and with reference to FIG. 1, the nickel alloy screen plate includes a bottom frame 5. In the embodiment of the present application, the bottom frame 5 is an aluminum-made frame in a shape of a rectangular ambulatory plane, which may also be referred to as an aluminum frame, a polyester screen is adhered to the aluminum frame, and a nickel alloy screen is adhered to the polyester screen. FIG. 1 is an exploded diagram of the nickel alloy screen plate, the polyester screen has the same external shape as the bottom frame 5, and the nickel alloy screen is arranged between the polyester screen and the bottom frame 5.

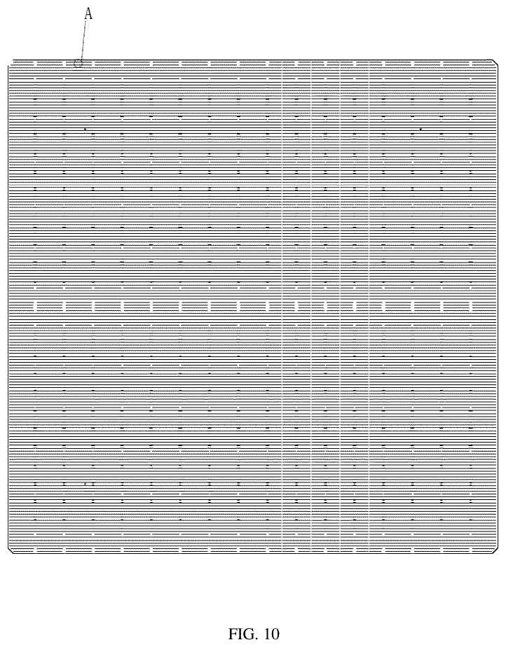

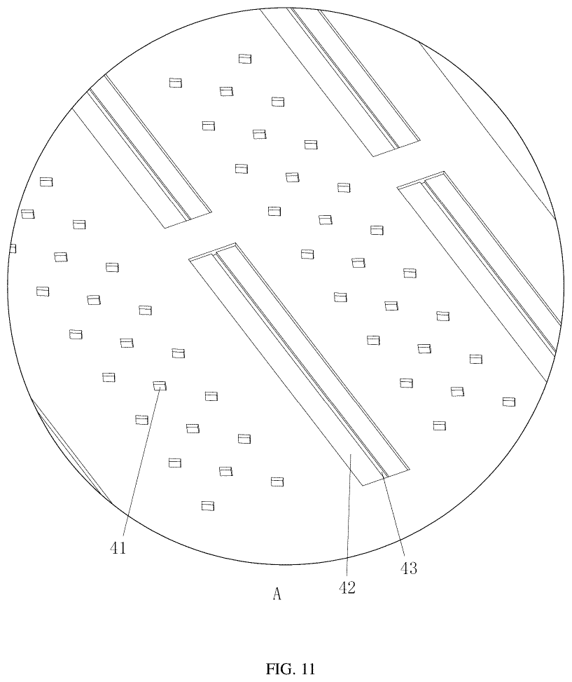

With reference to FIGS. 10, 11 and 12, there are two types of nickel alloy screens used in the embodiments of the present application. FIG. 10 shows a full-surface nickel alloy screen, and the lines in FIG. 10 represent gaps for ink leakage during the printing process. With reference to FIG. 11, square ink retaining grooves 41 are arranged on a first type of nickel alloy screen, and the ink retaining grooves 41 are each arranged at an equal interval from one another. An ink storage groove 42 is further formed on the nickel alloy screen, and a width of the ink storage groove 42 ranges from 50 microns to 200 microns. A silver paste groove 43 for leaking silver paste during printing is further formed on the nickel alloy screen. The silver paste groove 43 is provided on a bottom surface of the ink storage groove 42 and penetrates through mesh bars of the nickel alloy screen, and a width of the silver paste groove 43 ranges from 8 microns to 20 microns.

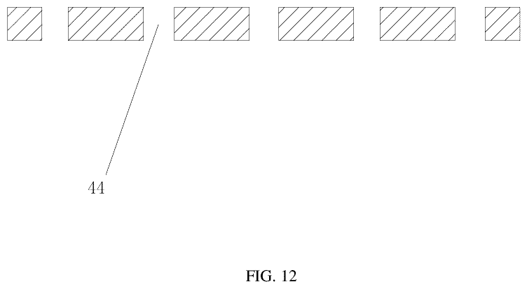

FIG. 12 is a schematic cross-sectional diagram of a second type of nickel alloy screen, which differs from the first type of nickel alloy screen in that the ink storage groove 42 is not formed on the second type of nickel alloy screen, an ink leakage groove 44 is formed on the second type of nickel alloy screen, a width of the ink leakage groove 44 ranges from 50 microns to 200 microns, and when printing ink passes through the nickel alloy screen, the printing ink flows out directly from a position of the ink leakage groove 44 for printing.

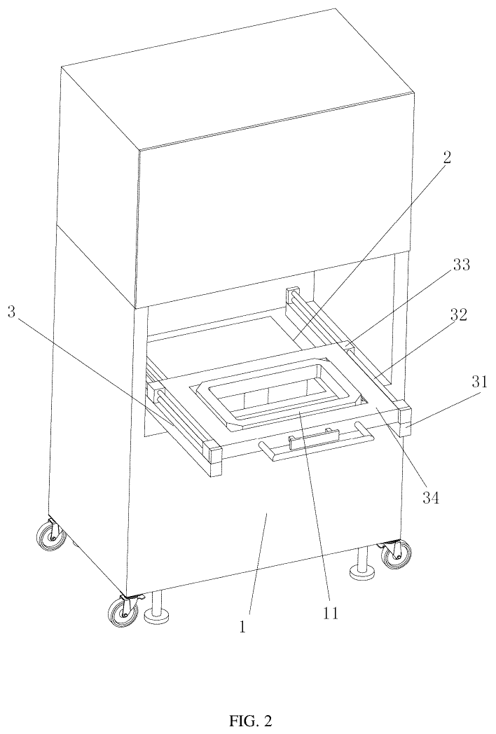

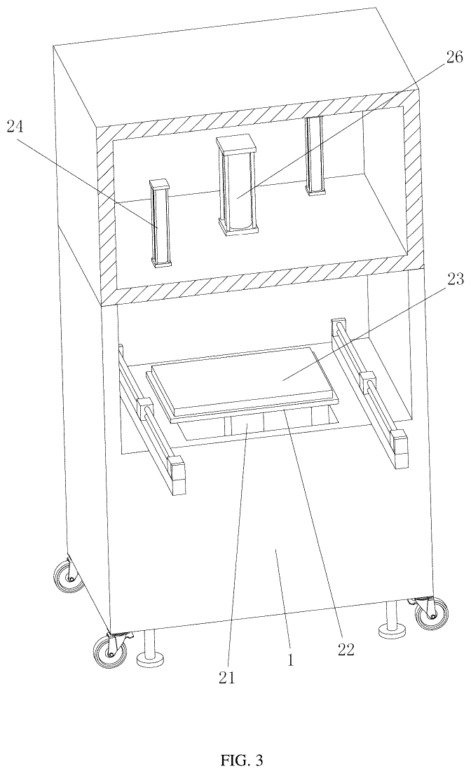

Disclosed in an embodiment of the present application is a nickel alloy screen plate hot-pressing device, and with reference to FIGS. 2 and 3, the nickel alloy screen plate hot-pressing device includes a machine case 1, a hot-pressing assembly 2 is mounted on the machine case 1, a transportation apparatus 3 is mounted on the machine case 1, and a frame of a shape of a rectangular ambulatory plane on the transportation apparatus 3 in FIG. 2 is a processing object, i.e., a first frame 11.

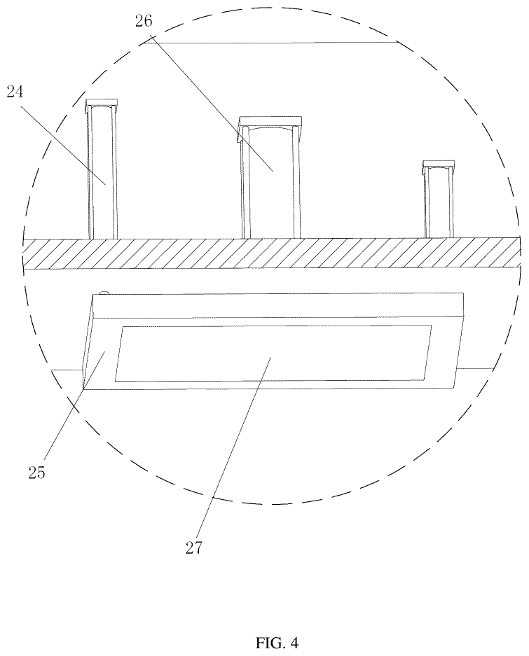

With reference to FIGS. 3 and 4, the hot-pressing assembly 2 includes a support column 21 fixedly mounted on the machine case 1, a base plate 22 is fixedly mounted on the support column 21, and a heating table 23 is fixedly mounted on the base plate 22. In the present embodiment, the heating table 23 is an electric heating table, and the electric heating table is a prior art, and the principle and use of the electric heating table will not be described in the present embodiment. A first cylinder 24 is fixedly mounted on the machine case 1, an output shaft of the first cylinder 24 is provided vertically downwards, a first pressing plate 25 is fixedly connected to the output shaft of the first cylinder 24, the first pressing plate 25 is provided above the heating table 23, an outer contour of the first pressing plate 25 is the same as that of the first frame 11, a second cylinder 26 is fixedly mounted on the machine case 1, an output shaft of the second cylinder 26 is provided vertically downwards, a second pressing plate 27 is fixedly connected to the output shaft of the second cylinder 26, and the second pressing plate 27 is provided above the heating table 23.

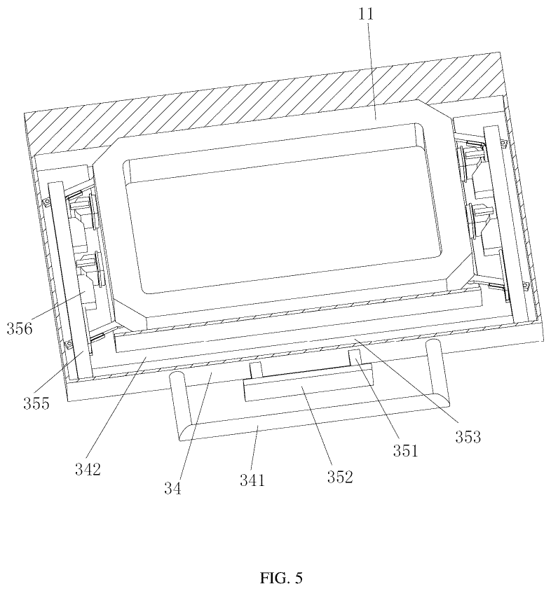

Referring to FIGS. 2 and 5, the transportation apparatus 3 includes a support table 31 fixedly mounted on the machine case 1, a first guide rod 32 is fixedly mounted on the support table 31, a first sliding block 33 is slidably mounted on the first guide rod 32, a carrier plate 34 for bearing the first frame 11 is fixedly mounted on the first sliding block 33, and a handle 341 is fixedly mounted on the carrier plate 34.

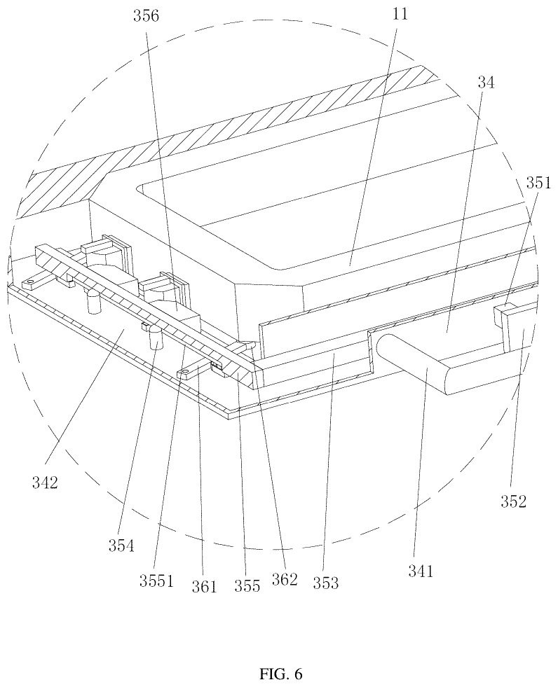

With reference to FIGS. 5 and 6, a mounting cavity 342 is formed on the carrier plate 34, a sliding rod 351 is slidably mounted on the carrier plate 34, a first end of the sliding rod 351 extends into the mounting cavity 342, a second end of the sliding rod 351 extends outside the carrier plate 34, a first push rod 352 is fixedly mounted on the second end, extending outside the carrier plate 34, of the sliding rod 351 and a second push rod 353 is fixedly mounted on the first end, extending into the mounting cavity 342, of the sliding rod 351. A support rod 354 is fixedly mounted on the carrier plate 34, the support rod 354 is provided in the mounting cavity 342, and a first end, away from a fixed end of the carrier plate 34, of the support rod 354 is provided as a spherical surface. A movable rod 355 is slidably connected on the support rod 354, a sliding groove 3551 is formed on the movable rod 355, the movable rod 355 is slidably connected to the support rod 354 via the sliding groove 3551, and a first end, close to the second push rod 353, of the movable rod 355 is fixedly connected to the second push rod 353.

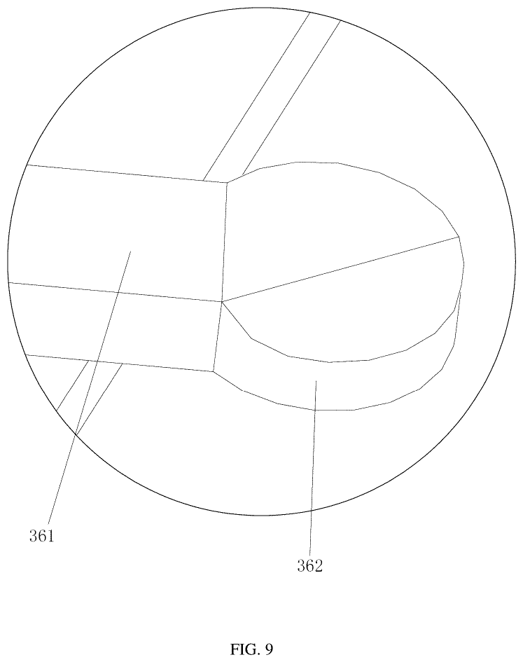

Referring to FIGS. 6, 7 and 8, a rotating rod 361 is rotatably mounted on the carrier plate 34, and a carrier sheet 362 for supporting the first frame 11 is fixedly mounted on the rotating rod 361. As shown in FIG. 9, the carrier sheet 362 is defined with an inclined surface inclined obliquely downward, a guide rail 363 is fixedly mounted on the rotating rod 361, and the guide rail 363 is divided into two sections, wherein a first section is provided in parallel with the rotating rod 361, and a second section is provided in parallel with the movable rod 355. A push plate 356 is fixedly mounted on the movable rod 355, and a first connecting rod 357 is fixedly mounted on the push plate 356, and a first end, away from the push plate 356, of the first connecting rod 357 is slidably connected to the guide rail 363.

A sliding rail 371 is fixedly mounted on the carrier plate 34, the sliding rail 371 is provided in the mounting cavity 342, a second guide rod 372 is fixedly mounted on the sliding rail 371, a second sliding block 373 is slidably mounted on the second guide rod 372, a first spring 374 is sleeved on the second guide rod 372, a first end of the first spring 374 is fixedly connected to the second sliding block 373, and a second end of the first spring 374 is fixedly connected to the sliding rail 371. A push block 375 is fixedly connected on the second sliding block 373, a first end, close to the push plate 356, of the push block 375 is defined with an outwardly convex arc-shaped surface, a first side, close to the push block 375, of the push plate 356 is defined with a beveled surface, and a position of the beveled surface of the push plate 356 abuts against the arc-shaped surface of the push block 375.

A mounting groove 3751 is provided on a second side, away from the push plate 356, of the push block 375, a third guide rod 376 is fixedly mounted on the push block 375, the third guide rod 376 is provided in the mounting groove 3751, a third sliding block 377 is slidably mounted on the third guide rod 376, a second spring 378 is sleeved on the third guide rod 376, a first end of the second spring 378 is fixedly connected on the third sliding block 377, and a second end of the second spring 378 is fixedly connected to the push block 375. A clamping plate 379 is fixedly mounted on the third sliding block 377, and a cushion block 3791 for increasing friction is fixedly mounted on the clamping plate 379. In this embodiment, the cushion block 3791 is a soft block made of high-temperature-resistant rubber or silicone material.

With reference to FIGS. 2 to 8, when transporting the first frame 11 to the heating table 23, the worker firstly places the first frame 11 on the carrier sheet 362, and the carrier sheet 362 bears the first frame 11. After the placement is completed, the worker holds the handle 341 to push the carrier plate 34 to slide on the first guide rod 32 until the carrier plate 34 is pushed to an terminal end of the first guide rod 32, at which moment the first frame 11 is just positioned above the heating table 23. The worker pushes the first push rod 352 into the carrier plate 34, and the first push rod 352 drives the sliding rod 351 and the second push rod 353 to move. The second push rod 353 drives the movable rod 355 to move in a direction away from the handle 341, and the movable rod 355 drives the push plate 356 to push the push block 375, and the push plate 356 pushes the push block 375 to move outward of the carrier plate 34 on the second guide rod 372 by the action of the inclined plane and the arc-shaped surface. When the push block 375 slides away from the inclined plane on the push plate 356, the clamping plate 379 and the cushion block 3791 are completely moved out of the carrier plate 34 to clamp the first frame 11 from a side of the first frame 11.

When the push plate 356 pushes the push block 375 to move, the push plate 356 drives the first connecting rod 357 to slide in the guide rail 363. When a highest point of the outwardly convex arc-shaped surface of the push block 375 just leaves the beveled surface of the push plate 356, the push plate 356 just drives the first connecting rod 357 to move to a section, parallel to the rotating rod 361, of the guide rail 363. At this time, when the push plate 356 continues to move such that the push block 375 abuts against a vertical side wall of the push plate 356, the first connecting rod 357 will toggle the rotating rod 361 to rotate via the action of the guide rail 363, such that the carrier sheet 362 on the rotating rod 361 is rotated into the mounting cavity 342. The movable rod 355 is controlled to move by the first push rod 352, such that the clamping plate 379 clamps and fixes the first frame 11, and during clamping and fixing, the carrier sheet 362 bearing the first frame 11 is moved to a side of the first frame 11. The bearing manner of the first frame 11 is quickly changed, so as to facilitate subsequent hot-pressing processing on the first frame 11.

When pressing the first frame 11 on the heating table 23, the first cylinder 24 controls the first pressing plate 25 to descend, and the first pressing plate 25 descends and presses the first frame 11. When the first pressing plate 25 presses the first frame 11, the first frame 11 drives the clamping plate 379 and the third sliding block 377 to slide downwards on the third guide rod 376 and compress the second spring 378. When the first pressing plate 25 leaves the first frame 11 after the processing of the first frame 11 is completed, the second spring 378 rebounds to push the clamping plate 379 and the third sliding block 377 to move upwards, such that the first frame 11 is lifted away from a table surface of the heating table 23, which is convenient for the worker to remove the first frame 11 out of the heating table 23 and collect the first frame 11. When collecting the first frame 11, the worker drags the carrier plate 34 away from a position above the heating table 23 via the handle 341, holds the first frame 11, and pulls the first push rod 352 to an outer side of the carrier plate 34. The first push rod 352 drives the movable rod 355 to move, the movable rod 355 drives the first connecting rod 357 to move, the first connecting rod 357 makes the carrier sheet 362 rotate to a position beneath the first frame 11 via the guide rail 363, and a beveled surface is defined on one side, which firstly moves to the position beneath the first frame 11, of the carrier sheet 362, so as to prevent the carrier sheet 362 from colliding with the side wall of the first frame 11, such that the carrier sheet 362 can smoothly move to the position beneath the first frame 11. When the carrier sheet 362 moves to the position beneath the first frame 11, the movable rod 355 drives the push plate 356 to move away from the push block 375, and when the push block 375 loses a pushing force from the push plate 356, the first spring 374 pushes the clamping plate 379 to move away from the first frame 11, such that the clamping plate 379 loosens the first frame 11, thereby facilitating quick replacement of the first frame 11 by a worker.

An embodiment of the present application further provides a process for manufacturing the nickel alloy screen plate, including the following steps:
Placing the polyester screen: placing a full-surface polyester screen on the heating table 23 for hot-pressing processing by a worker firstly;
Placing an adhesive film: placing the first adhesive film on the polyester screen by the worker, wherein the first adhesive film is contoured in a shape of a rectangular ambulatory plane;
Placing the first frame 11 for hot-pressing: placing the first frame 11 on the carrier plate 34 of the transportation apparatus 3 by the worker, transporting the first frame 11 to a position above the heating table 23 via the transportation apparatus 3, controlling the first pressing plate 25 via the first cylinder 24 of the hot-pressing assembly 2 to press the first frame 11 onto the first adhesive film; wherein, a hot-pressing temperature is set to 170 °C, a hot-pressing time is 160 seconds, and bonding the first frame 11 and the polyester screen together by using the first adhesive film via the hot-pressing assembly 2;
Hot-pressing the nickel alloy scree: after the hot-pressing of the first frame 11 is completed, the first pressing plate 25 continuing to press the first frame 11, then placing a square nickel alloy screen on the first adhesive film at a right center of the first frame 11 by the worker, wherein the nickel alloy screen is provided with an adhesive border, and only the adhesive border of the nickel alloy screen needs to be hot-pressed with the polyester screen; and after the placement of the nickel alloy screen is completed, the second cylinder 26 controlling the second pressing plate 27 to be hot-pressed on the polyester screen and the nickel alloy screen, and adhering the nickel alloy screen on the polyester screen via the first adhesive film;
Cutting the polyester screen: after the hot-pressing of the nickel alloy screen is completed, lifting the first pressing plate 25 and the second pressing plate 27 away from the first frame 11, and removing the first frame 11 from the transportation apparatus 3 by the worker and cutting the polyester screen, wherein an area of the polyester screen cut is less than an area of the nickel alloy screen;
Pasting the first frame 11 with an aluminum frame: preparing the aluminum frame in a shape of a rectangular ambulatory plane, wherein a frame size of the aluminum frame in the shape of the rectangular ambulatory plane is smaller than that of the first frame 11 such that the aluminum frame in the shape of the rectangular ambulatory plane can be placed in the first frame 11, and placing the aluminum frame on a frame lifting machine, wherein, in this embodiment, the frame lifting machine is a prior art, and the frame lifting machine can lift the aluminum frame for lifting; then placing the first frame 11 directly above the aluminum frame and one side, pasted with the polyester screen, of the first frame 11 facing upwards, and performing straightness adjustment by the worker, such that an edge line of the square nickel alloy screen is parallel to an edge line of the aluminum frame and the square nickel alloy screen is located at a right center of the aluminum frame; fixing the first frame 11 after the straightness adjustment is completed, and then gluing an adhesive on the aluminum frame, after the gluing is completed, the frame lifting machine lifting the aluminum frame to make the aluminum frame rise to contact with the polyester screen on the first frame 11, at which moment a height of the aluminum frame lifted is controlled by the frame lifting machine, and then detecting and adjusting a tension of the polyester screen using a pressure meter by the worker, and maintaining a warp tension at 9N and a weft tension at 7N after the aluminum frame lifts the polyester screen;
Cutting the polyester screen again: since a size of the aluminum frame is smaller than that of the first frame 11, after the aluminum frame is adhered to the polyester screen, there is a gap between an outer ring of the aluminum frame and an inner ring of the first frame 11 in the shape of the rectangular ambulatory plane, cutting the polyester screen from the gap between the first frame 11 and the aluminum frame by the worker, and after the cutting is completed, both the nickel alloy screen and the polyester screen on the first frame 11 are now adhered to the aluminum frame, then adhering an adhesive tape to an edge of a cut polyester screen on the aluminum frame, and fixing the edge of the polyester screen on the aluminum frame; and
Coating film: coating a silicon dioxide film on the polyester screen and nickel alloy screen located on an inner side of the aluminum frame in the shape of the rectangular ambulatory plane.

The implementation principle of the embodiments of the present application is as follows: the worker first places the full-surface polyester screen on the heating table 23; then places the first adhesive film on the polyester screen, and places the first frame 11 on the carrier plate 34 of the transportation apparatus 3, the first frame 11 is transported to a position above the heating table 23 via the transportation apparatus 3, the first pressing plate 25 is controlled by the first cylinder 24 of the hot-pressing assembly 2 to press the first frame 11 onto the adhesive film, then the first frame 11 and the polyester screen were bonded together by using the adhesive film, the first pressing plate 25 and the second pressing plate 27 are lifted away from the first frame 11 after the bonding is completed, and the first frame 11 is removed from the transportation apparatus 3 and the polyester screen is cut, such that the nickel alloy screen is exposed.

The above are all preferred embodiments of the present application, and are not intended to limit the scope of protection of the present application. Any equivalent changes made according to the structure, shape and principle of the present application shall be covered within the scope of protection of the present application.

### LISTING OF REFERENCE SIGNS

1, machine case;
11, first frame;
2, hot-pressing assembly;
21, support column;
22, base plate;
23, heating table;
24, first cylinder;
25, first pressing plate;
26, second cylinder;
27, second pressing plate;
3, transportation apparatus;
31, support table;
32, first guide rod;
33, first sliding block;
34, carrier plate;
341, handle;
342, mounting cavity;
351, sliding rod;
352, first push rod;
353, second push rod;
354, support rod;
355, movable rod;
3551, sliding groove;
356, push plate;
357, first connecting rod;
361, rotating rod;
362, carrier sheet;
363, guide rail;
371, sliding rail;
372, second guide rod;
373, second sliding block;
374, first spring;
375, push block;
3751, mounting groove;
376, third guide rod;
377, third sliding block;
378, second spring;
379, clamping plate;
3791, cushion block;
41, ink retaining groove;
42, ink storage groove;
43, silver paste groove;
44, ink leakage groove;
5, bottom frame.

1. (canceled)

2. A nickel alloy screen plate hot-pressing device for preparing a nickel alloy screen plate, comprising a machine case, wherein a hot-pressing assembly is mounted on the machine case, the hot-pressing assembly comprises a support column, the support column is mounted on the machine case, a base plate is mounted on the support column, a heating table is mounted on the base plate, a first pressing plate and a second pressing plate for pressing are mounted on the machine case, a transportation apparatus is mounted on the machine case, the transportation apparatus comprises a support table, a first guide rod is mounted on the support table, a first sliding block is slidably mounted on the first guide rod, and the first sliding block is connected to a carrier plate for transporting a first frame;
the nickel alloy screen plate comprises a bottom frame, wherein a polyester screen is adhered to the bottom frame, a nickel alloy screen is adhered to the polyester screen, an ink retaining groove, an ink storage groove and a silver paste groove are formed on the nickel alloy screen, the silver paste groove is provided on a bottom surface of the ink storage groove, and the silver paste groove penetrates through the nickel alloy screen;
wherein a mounting cavity is formed on the carrier plate, a sliding rod is slidably mounted on the carrier plate, a first end of the sliding rod extends into the mounting cavity, a second end of the sliding rod is provided outside the carrier plate, a first push rod is mounted on the second end, outside the carrier plate, of the sliding rod and a second push rod is connected to the first end, extending into the mounting cavity, of the sliding rod, a support rod is mounted on the carrier plate, a movable rod is slidably mounted on the support rod, a first end, close to the second push rod, of the movable rod is connected to the second push rod, a rotating rod is rotatably mounted on the carrier plate, a carrier sheet for bearing the first frame is mounted on the rotating rod, a push plate is mounted on the movable rod, and a first connecting rod for controlling rotation of the rotating rod is connected to the push plate.

3. (canceled)

4. The nickel alloy screen plate hot-pressing device according to claim 2, wherein a guide rail is mounted on the rotating rod, the first connecting rod is slidably connected to the guide rail, and the guide rail is divided into two sections, wherein a first section of the two sections is provided in parallel with the rotating rod, and a second section of the two sections is provided in parallel with the movable rod.

5. The nickel alloy screen plate hot-pressing device according to claim 2, wherein the carrier sheet is defined with an inclined surface.

6. The nickel alloy screen plate hot-pressing device according to claim 2, wherein a sliding rail is mounted on the carrier plate, a second guide rod is mounted on the sliding rail, a second sliding block is slidably mounted on the second guide rod, a first spring is sleeved on the second guide rod, a first end of the first spring is connected to the second sliding block, a second end of the first spring is connected to the sliding rail, a push block is mounted on the second sliding block, a first end, close to the push plate, of the push block is connected to the push plate, and a clamping plate for fixing the first frame is mounted on the push block.

7. The nickel alloy screen plate hot-pressing device according to claim 6, wherein a first side, close to the push block, of the push plate is defined with a beveled surface, a first side, close to the push plate, of the push block is defined with an outwardly convex arc-shaped surface, and a position of the beveled surface of the push plate abuts against the outwardly convex arc-shaped surface of the push block.

8. The nickel alloy screen plate hot-pressing device according to claim 6, wherein a third guide rod is mounted on the push block, a third sliding block is slidably mounted on the third guide rod, a second spring is sleeved on the third guide rod, a first end of the second spring is connected on the third sliding block, a second end of the second spring is connected to the push block, and the clamping plate is connected on the third sliding block.

9. The nickel alloy screen plate hot-pressing device according to claim 6, wherein a soft cushion block is mounted on the clamping plate.

10. A process for manufacturing the nickel alloy screen plate using the nickel alloy screen plate hot-pressing device according to claim 2, comprising the following steps:
step 1, hot-pressing the polyester screen by placing the polyester screen at a hot-pressing position of the hot-pressing assembly, and laying a first adhesive film on the polyester screen by a worker; and then transporting the first frame onto the first adhesive film via the transportation apparatus by the worker, and bonding the first frame and the polyester screen together by using the first adhesive film via the hot-pressing assembly;
step 2, hot-pressing the nickel alloy screen by laying the nickel alloy screen on the first adhesive film, and bonding the nickel alloy screen to the polyester screen by using the first adhesive film via the hot-pressing assembly;
step 3, cutting the polyester screen, wherein an area of the polyester screen cut is smaller than an area of the nickel alloy screen;
step 4, pasting an aluminum frame on the polyester screen by preparing the aluminum frame, wherein a frame size of the aluminum frame is smaller than that of the first frame and the aluminum frame is able to be placed inside the first frame, placing the first frame above the aluminum frame and adjusting a position of the first frame such that an edge line of the nickel alloy screen is aligned with an edge line of the aluminum frame to ensure that the nickel alloy screen is at a center position of the aluminum frame, and gluing an adhesive on the aluminum frame and lifting the aluminum frame and pasting the aluminum frame with the polyester screen on the first frame;
step 5, controlling a tension of the polyester screen by detecting a surface tension of the polyester screen by using a tension meter by the worker, and adjusting the tension of the polyester screen by changing a height of the polyester screen lifted by the aluminum frame;
step 6, cutting the polyester screen again by cutting the polyester screen between the first frame and the aluminum frame by the worker; and
step 7, after the cutting is completed, pasting an edge line of a cut polyester screen with the adhesive, such that the edge line of the cut polyester screen is pasted on the aluminum frame.

11. A process for manufacturing a nickel alloy screen plate using a nickel alloy screen plate hot-pressing device, the nickel alloy screen plate comprising a bottom frame, wherein a polyester screen is adhered to the bottom frame, a nickel alloy screen is adhered to the polyester screen, an ink retaining groove, an ink storage groove and a silver paste groove are formed on the nickel alloy screen, the silver paste groove is provided on a bottom surface of the ink storage groove, and the silver paste groove penetrates through the nickel alloy screen; and the nickel alloy screen plate hot-pressing device comprising a machine case, wherein a hot-pressing assembly is mounted on the machine case, the hot-pressing assembly comprises a support column, the support column is mounted on the machine case, a base plate is mounted on the support column, a heating table is mounted on the base plate, a first pressing plate and a second pressing plate for pressing are mounted on the machine case, a transportation apparatus is mounted on the machine case, the transportation apparatus comprises a support table, a first guide rod is mounted on the support table, a first sliding block is slidably mounted on the first guide rod, and the first sliding block is connected to a carrier plate for transporting a first frame;
wherein the process comprises the following steps:
step 1, hot-pressing the polyester screen by placing the polyester screen at a hot-pressing position of the hot-pressing assembly, and laying a first adhesive film on the polyester screen by a worker; and then transporting the first frame onto the first adhesive film via the transportation apparatus by the worker, and bonding the first frame and the polyester screen together by using the first adhesive film via the hot-pressing assembly;
step 2, hot-pressing the nickel alloy screen by laying the nickel alloy screen on the first adhesive film, and bonding the nickel alloy screen to the polyester screen by using the first adhesive film via the hot-pressing assembly;
step 3, cutting the polyester screen, wherein an area of the polyester screen cut is smaller than an area of the nickel alloy screen;
step 4, pasting an aluminum frame on the polyester screen by preparing the aluminum frame, wherein a frame size of the aluminum frame is smaller than that of the first frame and the aluminum frame is able to be placed inside the first frame, placing the first frame above the aluminum frame and adjusting a position of the first frame such that an edge line of the nickel alloy screen is aligned with an edge line of the aluminum frame to ensure that the nickel alloy screen is at a center position of the aluminum frame, and gluing an adhesive on the aluminum frame and lifting the aluminum frame and pasting the aluminum frame with the polyester screen on the first frame;
step 5, controlling a tension of the polyester screen by detecting a surface tension of the polyester screen by using a tension meter by the worker, and adjusting the tension of the polyester screen by changing a height of the polyester screen lifted by the aluminum frame;
step 6, cutting the polyester screen again by cutting the polyester screen between the first frame and the aluminum frame by the worker; and
step 7, after the cutting is completed, pasting an edge line of a cut polyester screen with the adhesive, such that the edge line of the cut polyester screen is pasted on the aluminum frame.
